(19) United States
(12) Patent Application Publication
(10) Pub. No.: US 2018/0252915 A1
(43) Pub. Date: Sep. 6, 2018

(54) HEAD-UP DISPLAY DEVICE WITH NARROW ANGLE DIFFUSION SHEET

(71) Applicant: E-LEAD ELECTRONIC CO., LTD., CHANGHUA (TW)

(72) Inventor: Stephen CHEN, CHANGHUA (TW)

(21) Appl. No.: 15/446,998

(22) Filed: Mar. 1, 2017

(51) Int. Cl. G02B 27/01; G02B 5/02; G02B 5/09

(52) U.S. Cl. CPC G02B 27/0101; G02B 5/0284; G02B 2027/0118; G02B 5/0231; G02B 5/09

(57) ABSTRACT

The present invention relates to a head-up display device with narrow angle diffusion sheet, which includes a projection module, a narrow angle diffusion sheet and a reflector, a micro concave mirror array is used to provide an ideal narrow angle diffusion sheet to obtain optimized visual effects; the feature is that the projection module is located near the reflector, and the narrow angle diffusion sheet faces the projection module and the reflector, to thereby overcome restrictions on use and solve brightness problem of head-up display devices, to obtain optimized visual effects, to improve driving safety.

### BACKGROUND OF THE INVENTION

### a) Field of the Invention

The present invention relates to a head-up display device with narrow angle diffusion sheet and, more particularly, to a head-up display device for optimized visual effects, wherein a close-to-ideal narrow angle diffusion sheet is consisted of an array of micro concave mirrors to overcome restrictions on use and solve brightness problem of head-up display devices, to obtain optimized visual effects, to thereby improve driving safety.

### b) Description of Prior Art

Recently, head-up display technology used in vehicles is an optical system, which is usually consisted of a projector and a combiner, wherein the projector is consisted of a signal light source, a projection lens and other optical elements; the signal light source of the projector is consisted of a LCD monitor, or a projector and an imaging screen or a diffusion sheet; light is emitted from the signal light source, and then projected to the combiner (specific translucent concave mirror) on the dashboard or the windshield by the projector, texts or images shown by the combiner are overlapped with actual scene in front of users, this combination of head-up displays is called CHUD (combiner type HUD); in another type of HUD, light is emitted from the signal light source, and then projected to the concave mirror under the dashboard by the projector and enlarged and reflected to the windshield, texts or images shown by the windshield are overlapped with actual scene in front of users, this combination of head-up displays is called WHUD (windshield type HUD).

A conventional WHUD (windshield type HUD) is limited by space, imaging distance of a general virtual image is usually not more than 2.5 meters from driver's eyes, but it is not enough in actual demands, so a target of 7 meters is set in the industry and manufacturers; the volume occupied by a conventional WHUD is very large, not all vehicles have enough space below the dashboard, so currently it is only for large vehicles, and the HUDs installed in small vehicles are all CHUD (combiner type HUD), the imaging distance of virtual images is even shorter.

However, for virtual images, long-distance imaging could be theoretically achieved by increasing the magnification of the concave mirror, but in actual, it would cause viewer dizzy; it may also be a solution for avoiding dizziness that enlarging the object distance composed of the concave mirror and a real image screen (the diffusion sheet of the projector or TFT), but the conventional one-piece HUD is limited by the space below the dashboard, so it is difficult to enlarge the object distance on the execution; for the same size of the real image screen, if the distance from the concave mirror is enlarged, virtual image distance may become farther, but the size of virtual images do not become larger, so the relative visual recognition may proportionally decline with distance.

For this reason, if the real image screen (the diffusion sheet of the projector or TFT) is set on the junction of vehicle roof and windshield, and the concave mirror is set under the dashboard, nearly three times the object distance of a conventional one-piece WHUD could be obtained (the original 18 cm becomes 50˜70 cm); also, its' occupied volume below the dashboard is smaller than a conventional HUD, so it could be applied in more vehicles; however, if the original visual recognition is desired to be maintained, at least the real image screen should be proportionally enlarged, but it is difficult to enlarge TFT, due to demands for high brightness backlight, a light cup behind TFT is needed to provide sufficient brightness, if TFT is enlarged from 1.8 inches to 5.4 inches, the whole TFT may become a very large TFT monster on the roof in front of the driver, it would not be accepted in cost and beauty.

As shown in FIG.1, for the projector 1 (including a DLP projector or a laser projector), an imaging screen or a diffusion sheet should be used as an imaging plane for imaging; for a rear projection projector, it is placed in the back of a diffusion sheet, and a translucent penetrating diffusion sheet may be used. The principle of the projector 1 is scanning an image and projecting light spots with different color and brightness to each point of the projected plane, an image would consist of the light spots; if the imaging plane is not a screen or a diffusion sheet, but a reflection plane 21 of a mirror reflector 2, since the angle of incidence of the reflector is equal to the angle of reflection, only one light point of the image projected to the mirror reflector 2 from the projector 1 may be reflected to eyes E of a specific viewer, the viewer can see only one point of light at any angle, cannot see a complete image.

As shown in FIG. 2, in order to show a whole image, the reflection plane for the projector 1 to project cannot be a mirror reflective plane, it should be a matte plane 22, so that light is scattered when being projected to the matte plane 22, reflected light may scatter to every reflection angle, and the matte plane 22 is called a diffusion sheet; light is emitted to a plane, part of the light would be absorbed, rest of the light would be reflected, if the reflected light is diffused to every angle, the whole image may be viewed in each angle, but the amount of light in each angle become very small, therefore, the projector 1 is usually used in a relatively dim environment; a better projection screen may contain powder for enhancing reflection, which could reduce the absorption of light and increase the intensity of reflected light, the cost may increase a lot but the effect may be very limited; it is only to reduce the proportion of light absorbed in this way, but not helpful to the losses generated by the light scattered to every angle.

In order to solve the above problems, various solutions have been proposed in the industry, related technology can refer to cited references TW public number 201636680, TW public number 201624101, TW patent number I367405, TW patent number I449950, TW patent number I506299, TW patent number I479236, TW patent number I485432, TW patent number M455182, TW patent number M328014.

In the above cited references, most of them may improve the functions of prior head-up display devices, but there are still some bottlenecks difficult to overcome, for example:

1. In the above public cited references, although some of them have already used the technology of reflector array, since there is still visual discrepancy between the projected standard range images and actual range images, for some drivers, this kind of phenomenon of visual discrepancy may easily cause dizziness in visual, thus it may affect driving safety.

2. In known technology, since a longer space and distance are needed by light source projection, not all of the vehicles could meet the requirement, so that expensive equipments may be asked for improving the efficiency and brightness of reflection; such as a projection module (or a projector) with wide viewing angle for overcoming restrictions of HUD (head-up display device; in this way, it is only increasing the cost of equipments and the projection efficiency is low, this is a general problem of prior head-up display devices.

### SUMARRY OF THE INVENTION

In view of the drawbacks of the conventional ones, the inventor finally completed the head-up display device with narrow angle diffusion sheet of the present invention after numerous improvements, namely, the object of the present invention is to provide a head-up display (HUD) for optimized visual effects, wherein a close-to-ideal narrow angle diffusion sheet is consisted of an array of micro concave mirrors, so that the reflected light is diffused to the concave mirror of HUD, so as to overcome restrictions on use and solve brightness problem of head-up display devices, to obtain optimized visual effects, to thereby improve driving safety.

To achieve the object, the head-up display device with narrow angle diffusion sheet of the present invention, which includes:

a projection module, which is provided to project an image light source;

a narrow angle diffusion sheet, which is an array of micro concave mirror, the image light source is projected to the narrow angle diffusion sheet;

a reflector, the image light source is reflected to the reflector by the narrow angle diffusion sheet;

the feature is that the projection module is located in the same side of the reflector, and the narrow angle diffusion sheet faces the projection module and the reflector.

The above array of the micro concave mirrors is arranged as a rectangular array.

Each of the above micro concave mirrors is a right cone type concave mirror, and the projection module is located near the reflector.

Each of the above micro concave mirrors is a spherical concave mirror, and the projection module is located near the reflector.

Each of the above micro concave mirrors is a curved concave mirror.

The above array of micro concave mirrors, wherein each of the micro concave mirrors forms an oblique angle with the narrow angle diffusion sheet.

The above array of micro concave mirrors, wherein all of the micro concave mirrors have different angles.

The above narrow angle diffusion sheet is a surface including at least a turning face.

The above reflector is a concave mirror.

The above narrow angle diffusion sheet is a curved surface.

The feature of the present invention is to provide the ideal narrow angle diffusion sheet by using the array of the micro concave mirrors, so that the range of diffused reflective light could be roughly covered the concave mirror of HUD without extra cost of using a projection module (or a projector) with wide viewing angle, to thereby overcome restrictions of HUD (head-up display device) on use. The ideal narrow angle diffusion sheet of the present invention is a diffusion sheet consisted of the array of the micro concave mirrors, the brightness of DLP imaging to the concave mirrors of HUD may increase more than ten times, even a hundred times by using the present invention, to thereby effectively solve the brightness problem of the projector of HUD, to provide a head-up display device with optimize visual effects, to thereby improve driving safety.

### BRIEF DESCRIPTION OF THE DRAWINGS

FIG. 1 is a schematic diagram of an embodiment of a conventional projection device;

FIG. 2 is a schematic diagram of another embodiment of a conventional projection device;

FIG. 3 is a schematic diagram of the first embodiment of the present invention;

FIG. 4 is a schematic diagram of the second embodiment of the present invention;

FIG. 4-1 is a partially enlarged schematic diagram of the second embodiment of the present invention;

FIG. 5 is a schematic diagram of the third embodiment of the present invention;

FIG. 5-1 is a partially enlarged schematic diagram of the third embodiment of the present invention;

FIG. 6 is a schematic diagram of the fourth embodiment of the present invention;

FIG. 6-1 is a partially enlarged schematic diagram of the fourth embodiment of the present invention;

FIG. 7 is a schematic diagram of the fifth embodiment of the present invention; and

FIG. 8 is a schematic diagram of the sixth embodiment of the present invention.

### DETAILED DESCRIPTION OF THE INVENTION

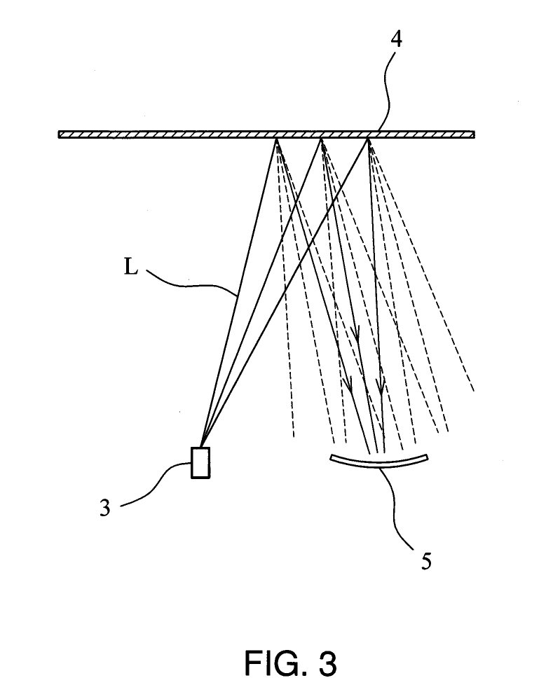

Please refer to FIG. 3, the first embodiment of the head-up display device with narrow angle diffusion sheet of the present invention, which includes:

a projection module 3, which is provided to project an image light source L, the projection module 3 is a DLP (Digital Light Processing) projector, which is an imaging technology used in projectors and rear projection televisions,

a narrow angle diffusion sheet 4, which is a narrow angle diffusion sheet consisted of an array of micro concave mirrors, the image light source L of the projection module 3 is projected to the narrow angle diffusion sheet 4;

a reflector 5, the image light source L is reflected to the reflector 5 by the narrow angle diffusion sheet 4, the reflector 5 is a concave mirror;

the feature is that the projection module 3 is located in the same side of the reflector 5, and the narrow angle diffusion sheet 4 faces the projection module 3 and the reflector 5.

The image light source L of the projection module 3 is reflected by the narrow angle diffusion sheet 4 of the present invention and just projected on the range of the reflector 5, so that the best projection efficiency could be obtained, because the reflected light projected to outside of the reflector 5 is wasted if the projected area is too large; a common head-up display device may be used under sunlight, thus high brightness is needed, this is a big challenge for the brightness of the projection module 3, so it is a very important subject that the light output from the projection module 3 should be fully used without wasting, the key of the subject is the design of the narrow angle diffusion sheet 4; for an ideal narrow angle diffusion sheet 4, its light reflectivity is best to reach 100%, and the reflected image light source L can be just cover the reflector 5 of the head-up display device but not exceed; the closer the ideal narrow angle diffusion sheet 4 is, the higher efficiency could be produced.

The above narrow angle diffusion sheet 4, wherein the array of the micro concave mirrors is a rectangular matrix arrangement consisted of a large number of the micro concave mirrors, namely, a rectangular arranged array is formed, each micro concave mirror is concentrated reflection to the reflector 5. For the reflector 5, each micro concave mirror represents a pixel on the display screen, so the amount of the micro concave mirrors represents the upper limit of screen resolution, for example, if the length is 480 and the width is 240, it means the array is consisted of 115200 micro concave mirrors, it limits the highest resolution of imaging even if the original resolution of the projection module is high, the key is still the amount of the micro concave mirrors of the narrow angle diffusion sheet 4 and its projection efficiency

The above narrow angle diffusion sheet 4, which is a narrow angle diffusion sheet consisted of an array of micro concave mirrors, the feature is that the projection module 3 is located near the reflector 5, its advantage is that the narrow angle diffusion sheet 4 could be brighter, not too matte, so that light absorption could be reduced to thereby increase reflectivity.

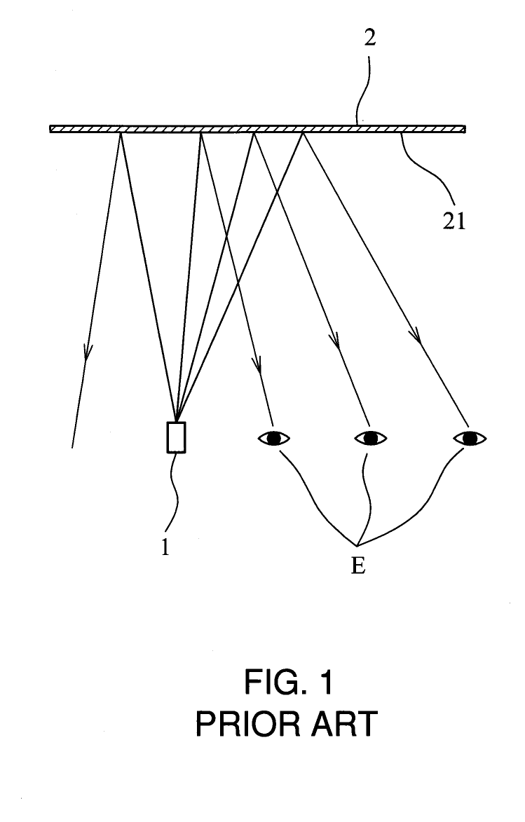

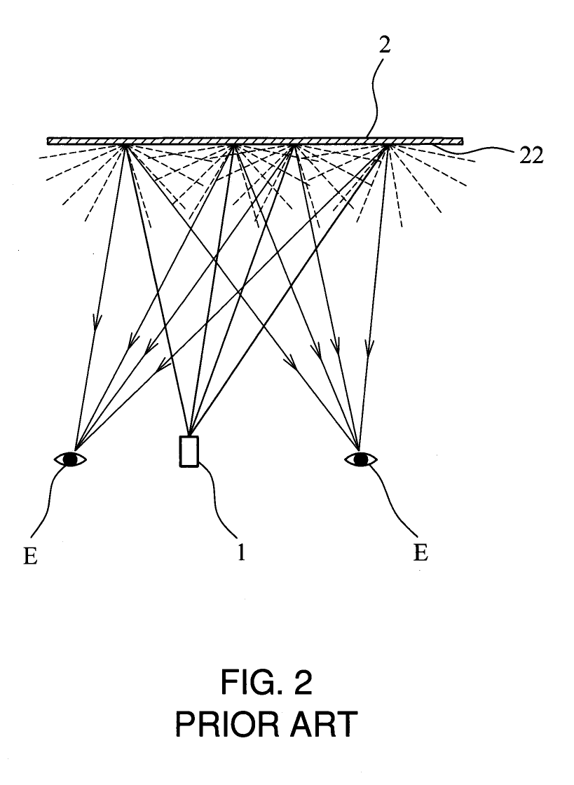

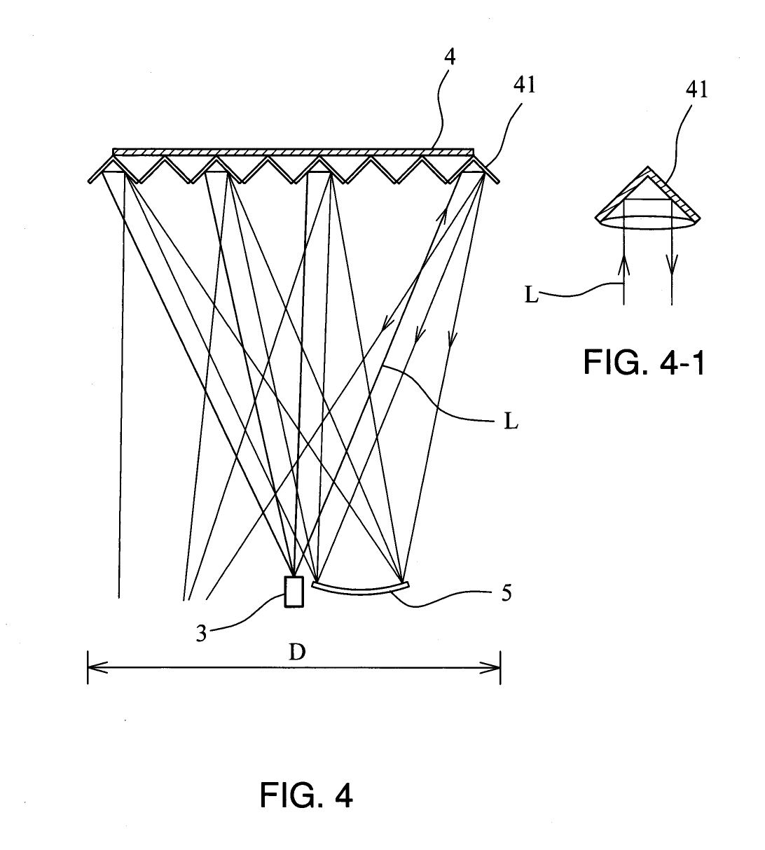

As shown in FIG. 4 and FIG. 4-1, which is the second embodiment of the narrow angle diffusion sheet of the present invention, the narrow angle diffusion sheet 4 is an narrow angle diffusion sheet consisted of an array of micro concave mirrors, the features is that the projection module 3 is located near the reflector 5, wherein each of the above micro concave mirrors is a right cone type concave mirror 41, and the array of the micro concave mirrors is an array of right cone type concave mirrors 41. According to the principle of the right angle characteristics of the right cone type concave mirror 41 that the incident line is parallel to the reflection line; if the right cone type concave mirrors 41 are complete glossy, the reflective light would be entirely reflected to the light source of the incident light; if the right cone type concave mirrors 41 are light matte, the reflective light would form a reflective surface with a specific area near the light source of the incident light, the reflector 5 could receive diffused reflective light in the reflection range D of the reflective surface.

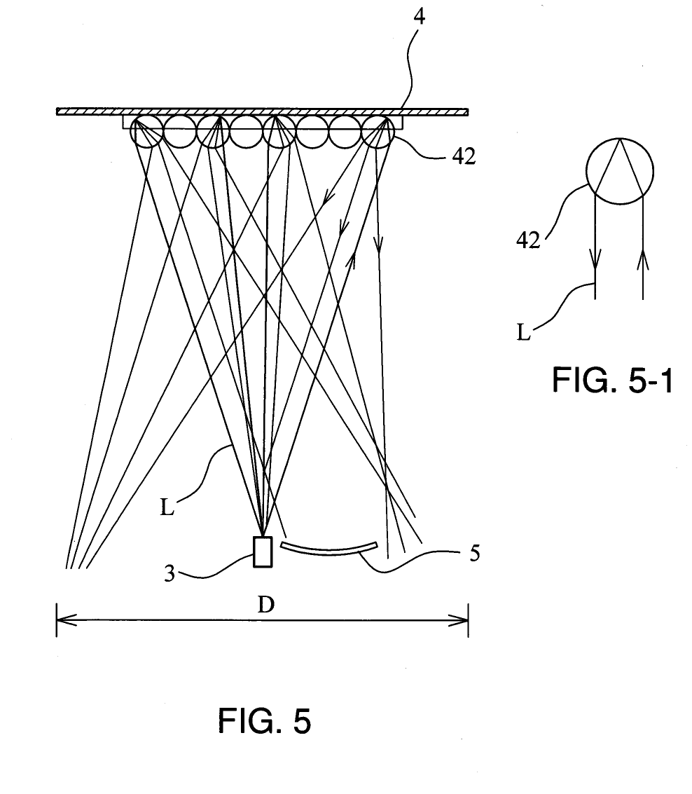

As shown in FIG. 5 and FIG. 5-1, which is the third embodiment of the narrow angle diffusion sheet of the present invention, the narrow angle diffusion sheet 4 is an narrow angle diffusion sheet consisted of an array of micro concave mirrors, the features is that the projection module 3 is located near the reflector 5, wherein each of the above micro concave mirrors is a spherical concave mirror 42, and the array of the micro concave mirrors is an array of spherical concave mirrors 42; if each of the spherical concave mirror 42 is a light matte concave mirror, according to the principle of the transparent spherical concave mirror 42 that the incident line is parallel to the reflection line, if the spherical concave mirrors 42 are complete glossy, the reflective light would be entirely reflected to the light source of the incident light; but if the spherical concave mirrors 42 are light matte, the reflective light would form a reflective surface with a specific area near the light source of the incident light, the reflector 5 could receive diffused reflective light in the reflection range D of the reflective surface.

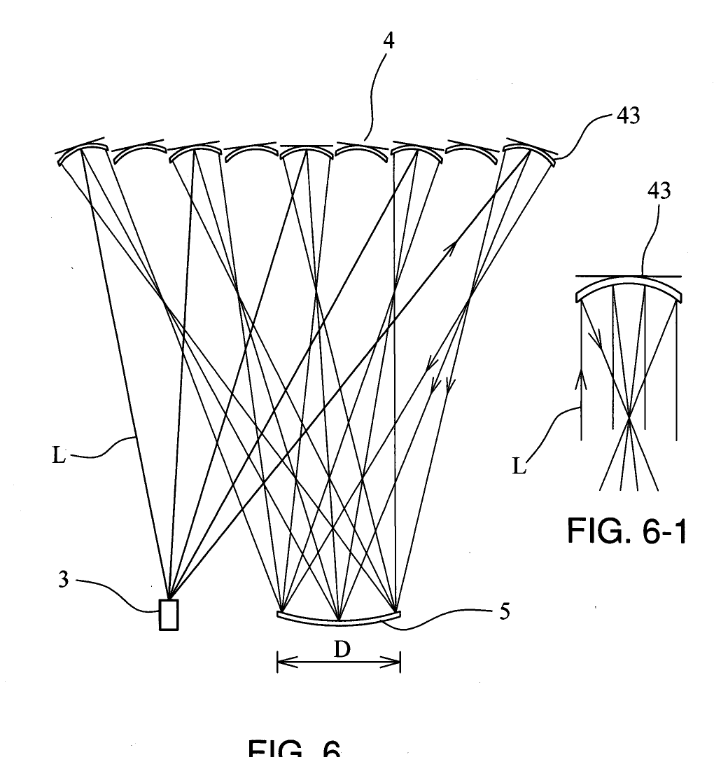

As shown in FIG. 6 and FIG. 6-1, which is the fourth embodiment of the narrow angle diffusion sheet of the present invention, the narrow angle diffusion sheet 4 is an narrow angle diffusion sheet consisted of an array of micro concave mirrors, wherein each of the above micro concave mirrors is a curved concave mirror 43, and the array of the micro concave mirrors is an array of curved concave mirrors 43. According to focus principle of the curved concave mirror 43, in the array of the curved concave mirror 43, each of the curved concave mirrors 43 is designed with different angle; light will spread out if the projection distance exceeds the concave mirror 43; once the locations of the light source of the projection module 3, the narrow angle diffusion sheet 4 and the reflector 5 have been determined, placing angle and arc radius of each curved concave mirror 43 of the narrow angle diffusion sheet 4 could be calculated precisely so that the reflective light of each curved concave mirror 43 could roughly cover the reflector 5 to achieve the most efficient use of light; the reflectivity of each curved concave mirror 43 of the array of the curved concave mirrors could be close to 100%, thus the light utilization of the whole projection module 3 could be almost more than 90%, it exceeds more than ten times the light utilization of the wide-angle diffusion sheet; therefore, the head-up display device with narrow angle diffusion sheet of the present invention is the most efficient projector diffusion sheet.

Each of the above micro concave mirrors is a curved concave mirror 43, the advantage of the array consisted of the curved concave mirrors 43 is to let its light absorption reduce to the minimum during reflection; besides, another advantage is to limit diffusion range of reflected light, let reflective light be fully concentrated and project on the reflector 5, especially if the micro concave mirror is a curved concave mirror 43, since the diffusion range of the array consisted of the curved concave mirrors 43 could be roughly equal to the range of the reflector 5, so that the image light source L output by the projection module 3 could be fully utilized.

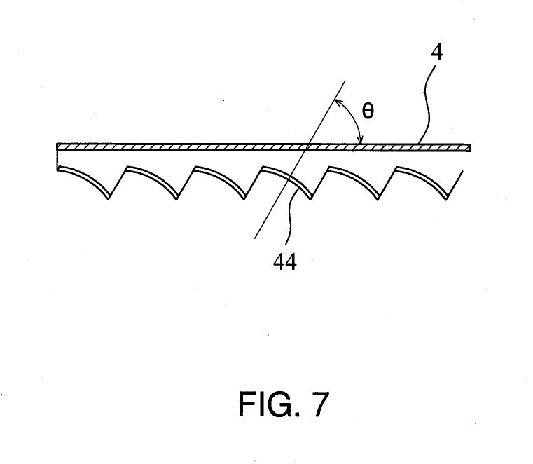

In AR HUD (augmented reality HUD), virtual images should be as parallel as possible with ground to let the virtual image of navigation arrow paste on the front road. For a common real image plane, such as TFT or a diffusion sheet of a conventional projector, the brightness vertical to the plane is highest; the greater the vertical angle, the lower the brightness; if virtual image is not vertical to driver's sight, the image brightness may be given up; as shown in FIG. 7, which is the fifth embodiment of the head-up display device of the present invention, wherein each of the micro concave mirrors 44 in the array of the micro concave mirror 44 forms an oblique angle 8 with the narrow angle diffusion sheet 4, to thereby let the diffusion sheet and the optical axis of HUD form an angle of θ+a (a means the determined difference of the angle), so that the virtual image of HUD and driver's sight form an angle of θ+a that it is more parallel with ground, to achieve the effect of combining virtual images with real images.

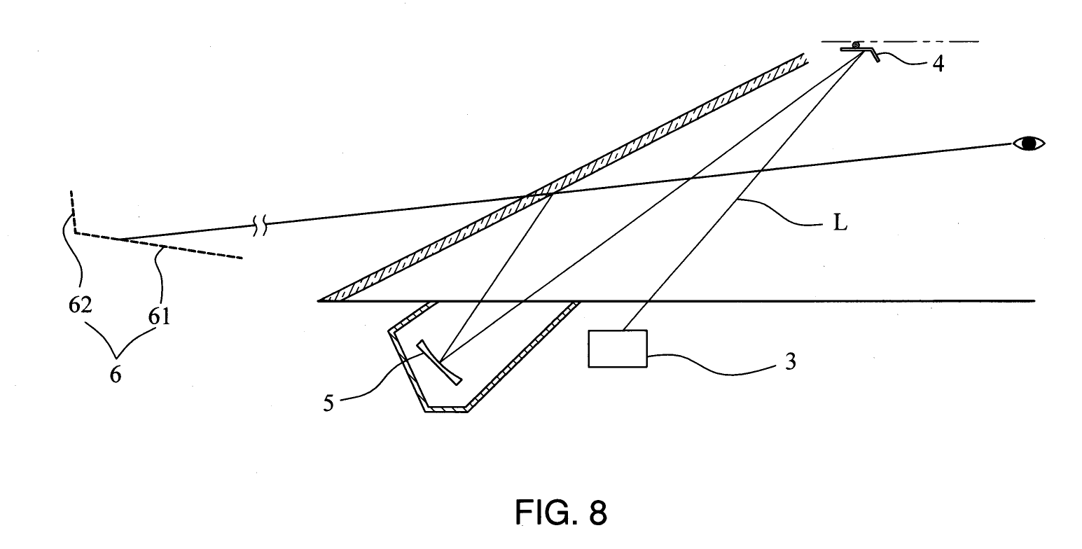

In AR HUD (augmented reality HUD), virtual images should be as parallel as possible with ground to let the virtual image of navigation arrow paste on the front road, but general information is still vertical to the area that the driver is easier to read as possible, an ideal HUD should has virtual images with different display angles according to different applications; as shown in FIG. 8, which is the sixth embodiment of the head-up display device with narrow angle diffusion sheet of the present invention, wherein the narrow angle diffusion sheet 4 is a curved surface or a surface including at least a turning face) to let images have a turn, so that the imaging of the virtual image 6 become three-dimensional; the display content of the head-up display device with the narrow angle diffusion sheet includes a symbol arrow 61 and a text 62, the symbol arrow 61 should be as parallel as possible with ground, images should be tended to parallel, but the text 62 should still be vertical for easily reading, so texts should be as vertical as possible.

The head-up display device with narrow angle diffusion sheet of the present invention, by implementation of the above embodiments, the best narrow angle diffusion sheet 4 could be provided by using the array of the micro concave mirrors of the narrow angle diffusion sheet 4, so that the range of diffused reflective light could be roughly covered the concave mirror of HUD without extra cost of using a projection module (or a projector) with wide viewing angle, to thereby overcome restrictions of HUD (head-up display device) on use. The ideal narrow angle diffusion sheet 4 of the present invention is a diffusion sheet consisted of the array of the micro concave mirrors,

the brightness of projector imaging to the concave mirrors of HUD may increase more than ten times, even a hundred times by using the present invention, to thereby effectively solve the brightness problem of the projector of HUD, to provide a head-up display device with optimize visual effects, to thereby improve driving safety.

What is claimed is:

1. A head-up display device with narrow angle diffusion sheet, which includes:
a projection module, which is provided to project an image light source;
a narrow angle diffusion sheet, which is an array of micro concave mirrors, the image light source is projected to the narrow angle diffusion sheet;
a reflector, the image light source is reflected to the reflector by the narrow angle diffusion sheet;
the feature is that the projection module is located in the same side of the reflector, and the narrow angle diffusion sheet faces the projection module and the reflector.

2. The head-up display device with narrow angle diffusion sheet as claimed in claim 1, wherein the array of the micro concave mirrors is arranged as a rectangular array.

3. The head-up display device with narrow angle diffusion sheet as claimed in claim 1, wherein each micro concave mirror is a right cone type concave mirror, the projection module is located near the reflector.

4. The head-up display device with narrow angle diffusion sheet as claimed in claim 1, wherein each micro concave mirror is a spherical concave mirror, the projection module is located near the reflector.

5. The head-up display device with narrow angle diffusion sheet as claimed in claim 1, wherein each micro concave mirror is a curved concave mirror.

6. The head-up display device with narrow angle diffusion sheet as claimed in claim 1, wherein each of the micro concave mirrors in the array of the micro concave mirrors forms an oblique angle with the narrow angle diffusion sheet.

7. The head-up display device with narrow angle diffusion sheet as claimed in claim 1, wherein all of the micro concave mirrors in the array of the micro concave mirrors have different angles.

8. The head-up display device with narrow angle diffusion sheet as claimed in claim 1, wherein the narrow angle diffusion sheet is a surface including at least a turning face.

9. The head-up display device with narrow angle diffusion sheet as claimed in claim 1, wherein the reflector is a concave mirror.

10. The head-up display device with narrow angle diffusion sheet as claimed in claim 1, wherein the narrow angle diffusion sheet is a curved surface.
